(19) United States
(12) Patent Application Publication
(10) Pub. No.: US 2005/0057015 A1
(43) Pub. Date: Mar. 17, 2005

(54) Pivot bearing for a vehicle

(76) Inventors: Michael Frantzen, Aachen (DE); Peter Porschen, Kerpen (DE); Wolfgang David, Aachen (DE); Torsten Hallfeldt, Eschweiler (DE); Marc Simon, Koeln (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/932,483

(22) Filed: Sep. 2, 2004

(30) Foreign Application Priority Data
Sep. 5, 2003 (EP) 03103299

(51) Int. Cl. B60G 1/00

(52) U.S. Cl. 280/124.144

(57) ABSTRACT

The invention relates to a pivot bearing for a vehicle having a base body for connecting wheel guiding elements to a wheel. The base body is composed of a planar piece of sheet metal to which a flange plate is assigned. The flange plate is connected to the base body in a frictionally locking fashion.

### BACKGROUND OF THE INVENTION

1. Field of the Invention

The invention relates to a pivot bearing for a vehicle having a base body for connecting wheel guiding elements to a vehicle wheel.

2. Background Art

U.S. Pat. No. 4,454,601 discloses an independent wheel suspension system for the steerable wheels of a vehicle in a design in which a strut unit which yields telescopically is arranged between the wheel and a section of the vehicle bodywork on each wheel. A drag arm element is pivotably mounted on the wheel and on the strut unit and is also mounted in a pivotable fashion on the chassis of the vehicle, in front of the wheel. The strut unit has a telescopic section and a carrier section. The carrier section is composed of a strut carrier pressed part which is permanently connected to the telescopic section, and of a steering stub axle carrier pressed part which is attached to the strut carrier pressed part so that a unit is formed. The strut carrier pressed part has integrally shaped sections in order to provide a pivotable connection to the drag arm element.

U.S. Pat. No. 5,145,204 relates to an independent suspension system for a rear wheel of a vehicle. A lightweight joint clip is pressed from a pair of front and rear components which are manufactured in mirror-inverted fashion, from a piece of sheet metal. The two components are welded to one another. Each component is formed with a semi-circular sleeve section which is arranged between outer and inner planar sections.

JP 60092908 A relates to a McPherson-like spring leg suspension. Here, a pivot bearing is bent in a U-shape out of a piece of sheet metal in order to hold the cylindrical damper. In the upper and lower sheet-metal parts of the pivot bearing, holes are provided so that a cylindrical part of the damper engages through them. The upper and lower sheet-metal parts are welded to the cylindrical part of the damper.

DE 199 15 633 A1 discloses a pivot bearing for, in particular, the front axle of a front-wheel drive motor vehicle having a base body composed of sheet-metal preshaped parts which can be connected to one another. Components for the wheel suspension and the wheel drive and also wheel brakes are attached to the sheet-metal preshaped parts. The sheet-metal preshaped parts and the components are manufactured from a titanium alloy material. The sheet-metal preshaped parts are manufactured by means of a deep-drawing process so that they are available as two sheet-metal preshaped parts which are of complementary design to one another and which, when joined to one another by means of a welded connection, form a hollow body with a plurality of connecting faces for holding the components.

DE 195 33 315 C1 relates to a steering stub axle, in particular for the front axle of a front-wheel drive motor vehicle, having a base body which is formed from sheet-metal preshaped parts which can be connected to one another and which surround a circumferential cavity in the connected state. The cavity is prepared to hold correspondingly adapted sections of components which reinforce the steering stub axle and which are used to fasten wheel suspension elements or steering elements or a brake to the steering stub axle.

Pivot bearings on vehicles are used to connect the vehicle wheel to the wheel guiding elements. Wheel guiding elements can be, for example, dampers, brakes, steering levers and transverse links. Pivot bearings can, however, also be fitted with wheel bearings. Because of the varied function and for safety reasons, the pivot bearings are often manufactured from relatively heavy and expensive casting steel. A number of pivot bearings are deep-drawn from pieces of sheet metal, the individual parts being connected to one another, mainly welded, to form one unit. Other pivot bearings are, however, also manufactured by means of superplastic or thixotropic shaping.

### SUMMARY OF INVENTION

The invention provides a pivot bearing for connecting wheel guiding elements to a wheel of a vehicle comprising a base body and a flange plate. The base body is comprised of a planar piece of sheet metal and the flange plate is connected to the base body in a frictionally locking fashion. One object of the invention is making available an improved pivot bearing which, while maintaining safety and fulfilling the wide variety of functions, is reduced in weight and has an increased degree of rigidity and can also be manufactured extremely economically.

In order to keep the manufacturing costs as low as possible, it is expedient if the base body is manufactured from a planar semifinished product. The base body is preferably manufactured in one piece from a planar, unshaped piece of sheet metal. In the preferred embodiment, the base body is punched from the planar piece of sheet metal. However, any other cutting method, for example laser cutting, is possible.

In order to provide reinforcement, the base body is assigned one or more flange plates. In order to increase the reinforcement, the flange plate advantageously has a projection. The flange plate is also manufactured in one piece with the projection from a planar piece of sheet metal, preferably punched out of it. However, laser cutting is also possible. If a wheel bearing is provided with a flange plate, the flange plate of the bearing can also be used.

In order to provide further reinforcement, the base body advantageously has reinforcing ribs. The reinforcing ribs can be embodied as reinforcing rods or as crimped elements or beads. In the case of thick pieces of sheet metal, separate reinforcing rods are preferably used for reinforcement purposes, crimped elements being provided as elevations or depressions in thin pieces of sheet metal. It is also conceivable to provide drawn beads.

Further advantageous embodiments of the invention are disclosed in the subclaims.

### BRIEF DESCRIPTION OF THE DRAWINGS

FIG. 1 shows a perspective view of a pivot bearing;

FIG. 2 shows a further perspective view of the pivot bearing from a side opposite FIG. 1;

FIG. 3 shows a perspective side view of the pivot bearing; and

FIG. 4 shows a further perspective view of the pivot bearing.

### DETAILED DESCRIPTION OF THE PREFERRED EMBODIMENTS

In the individual figures, identical parts are always provided with the same reference symbols, for which reason they are also generally only described once.

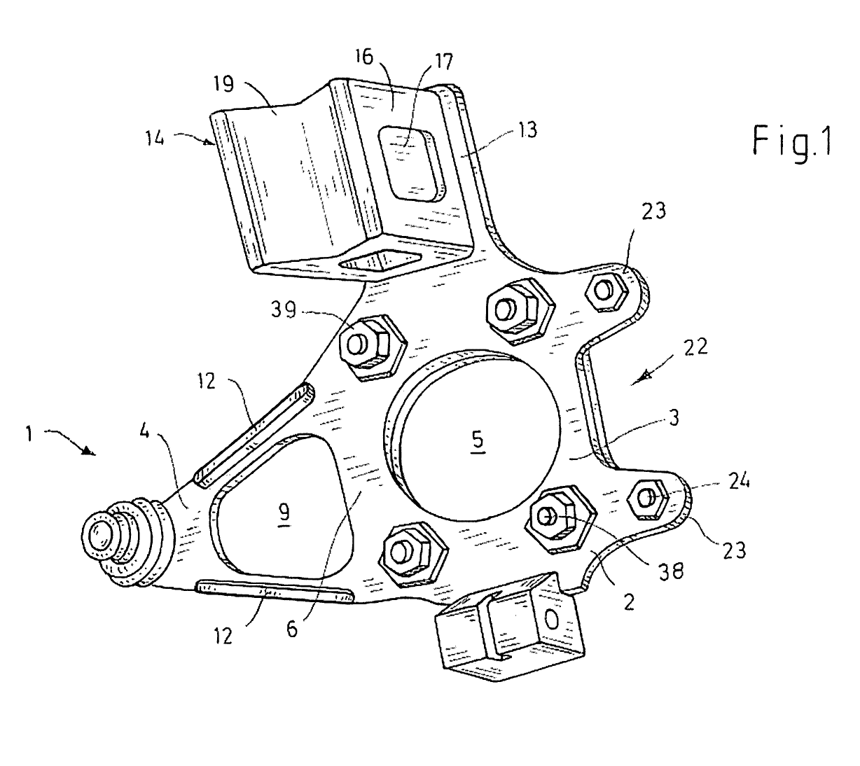

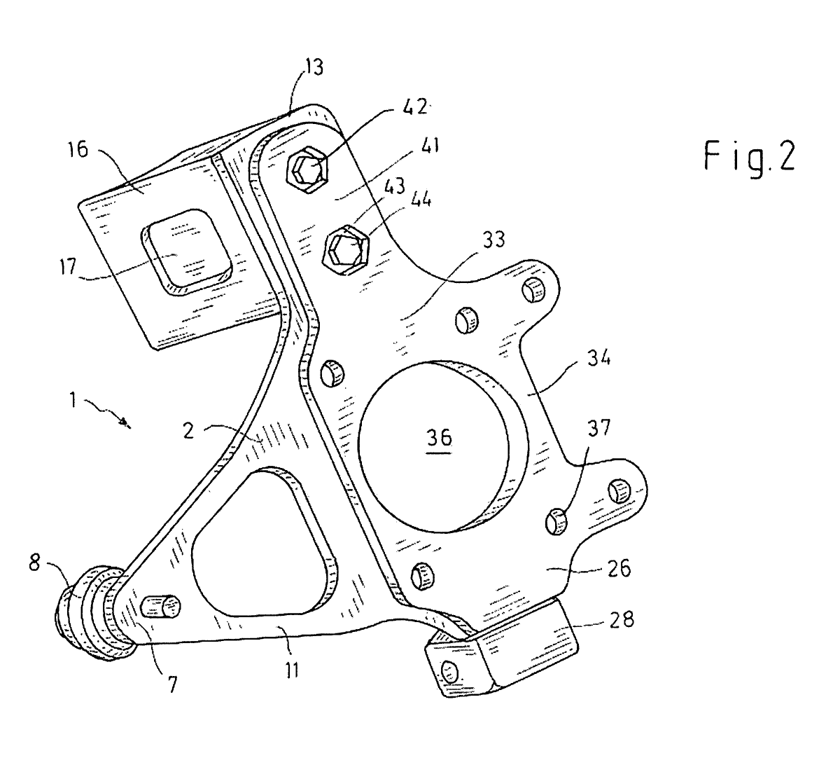

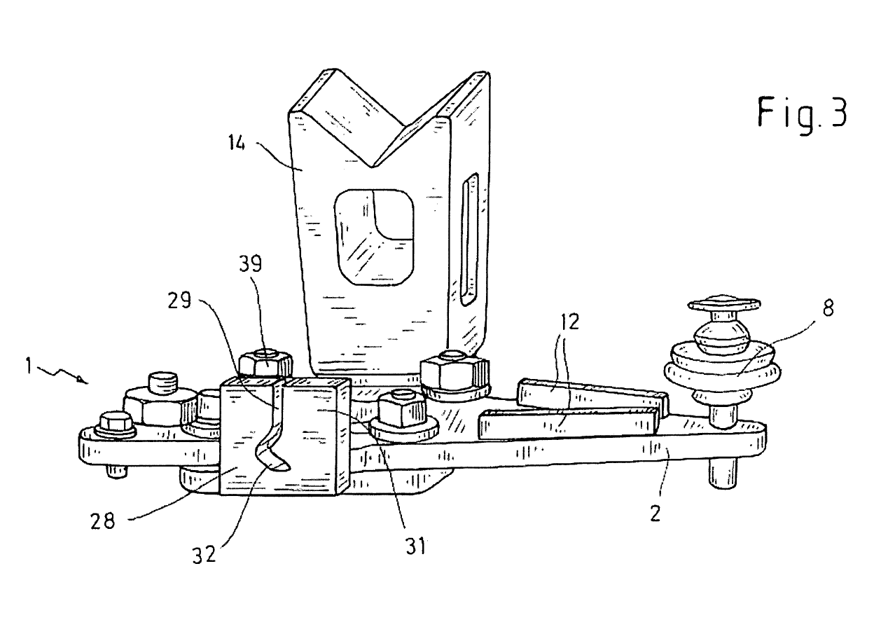

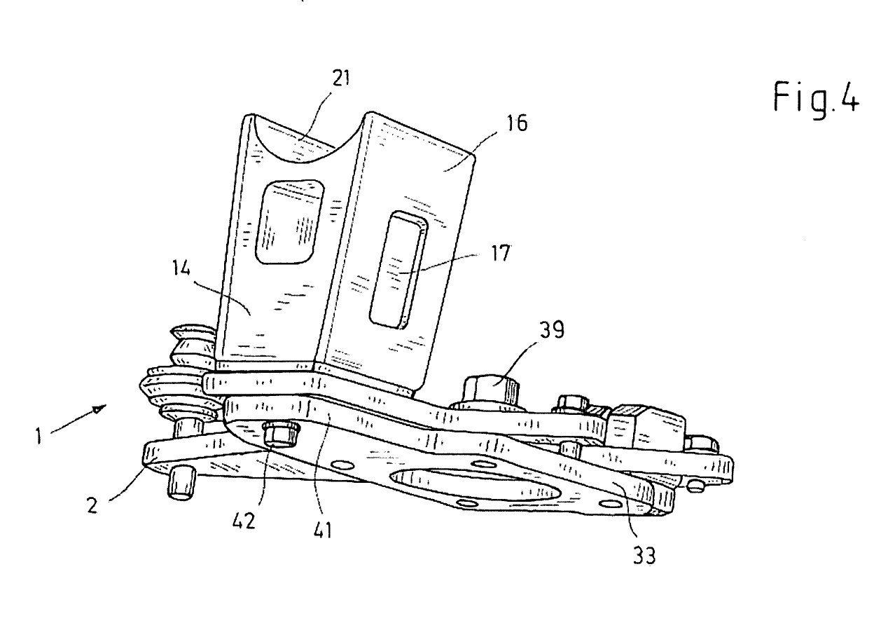

FIG. 1 shows a pivot bearing 1 with a base body 2 for connecting wheel guiding elements to a wheel. The pivot bearing 1, which is respectively illustrated in FIGS. 1 and 4 as well as in FIGS. 2 and 3, is assigned to wheels which are respectively arranged opposite one another on an axle. The base body 2 has an essentially square base surface 3 on which attachment elements for attaching elements for holding the wheel guiding elements such as, for example, dampers, brakes, steering levers and transverse links are provided. An opening 5 is arranged approximately centrally in the base surface 3 and is surrounded by insertion openings. The insertion openings are used to hold screws, which will be explained in more detail below. The base body 2 is fabricated in one piece with its attachment sections, from a piece of sheet metal. The base body 2 is preferably punched from the piece of sheet metal, but can also be cut out by means of a laser beam, for example.

A first attachment section 4 is of essentially triangular configuration and is used, for example, to attach the steering lever. The first attachment section 4 is arranged with its base side 6 on the base surface 3, a rounded tip 7 being directed away from the base surface 3, lying in a plane (FIG. 2). A bore for connecting to a steering lever ball-and-socket joint 8 is provided in the tip 7. A recess 9 is arranged in the first attachment section 4 so that webs 11 lead from the base side 6 to the tip 7 (FIG. 2).

In order to reinforce the base body 2, reinforcing ribs, which are connected in a materially joined fashion to the webs 11 as rectangular rods 12 in the illustrated exemplary embodiment are arranged on the webs 11 (FIGS. 1 and 3). However, it is also possible for crimped elements to be provided in the webs 11 for reinforcement purposes.

A second attachment section 13 is of essentially rectangular design and is used, for example, to attach the damper. The damper is connected to the second attachment section 13 of the base body 1 by means of a damper connecting element 14. The damper connecting element 14 is composed, by way of example, of steel or aluminum and is configured in the form of a hollow box, recesses 17 being arranged in its walls 16 in order to reduce the weight. The damper connecting element 14 is configured with one attachment side in a fashion which is complementary to the second attachment section 13. The attachment side is somewhat smaller than the second attachment section 13. The damper connecting element 14 is connected in a frictionally locking fashion to the second attachment section 13, which is described below in more detail. On a holding side 19 which lies opposite the attachment side, the damper connecting element 14 has a preferably semicircular depression 21 (FIGS. 1 and 4). The depression 21 can, however, also have different geometric shapes which provide the damper with sufficient grip. A damper rod, which is connected to the damper connecting element 14 in a conventional fashion, for example welded, is held in the depression 21.

A third attachment section 22 is arranged opposite the first attachment section 4. The third attachment section 22 is composed of two eyelets 23 which are spaced apart from one another. In each case, a bore, through which screws 24 can be guided, is arranged in the eyelets 23. The eyelets 23 are used to attach the brakes to the screws 24.

A fourth attachment section 26 is arranged opposite the second attachment section 13. Said attachment section 26 is configured as a projection. A connecting element 28 for connecting to the transverse link is preferably welded to the projection. The connecting element 28 has a gap 29 which is of hook-like configuration so that a type of guideway is formed (FIG. 3). As a result, the connecting element 28 has two clamping jaws 31. On the one hand, a through-opening and, on the other hand, a threaded hole are provided in the clamping jaws 31. A ball-and-socket joint of the transverse link is guided along the guideway to its end 32 and into the gap 29. In order to attach the transverse link securely, the two clamping jaws 31 are screwed together by means of a screw by inserting the screw through the through-opening and screwing it into the threaded hole. Alternatively, the connecting element 28 can also have a conical bore for holding a corresponding element of a transverse link.

A flange plate 33 is connected in a frictionally locking fashion to the base body 2 (FIG. 2). The flange plate 33 has an essentially square base surface 34 with a central opening 36 for conventionally attaching a wheel bearing. The base surface 34 is essentially of the same configuration as the base surface 3 of the base body 2, but can also be somewhat larger or smaller. Bores 37 are arranged around the opening 36. In the illustrated exemplary embodiment, the bores 37 are of hexagonal configuration in certain sections, corresponding to a hexagonal screw head so that the hexagonal screw head is held essentially free of play in the respective bores 37. In a section which adjoins the hexagonal section, the bores 37 have a diameter which is matched to a screw stem. The hexagonal section is introduced into the flange plate 33 to such a depth that the screw head is completely received in the bore. In order to connect the flange plate 33 to the base body 2, the bores 37 are laid congruently against the insertion openings in the base body 2. By means of a screw 38, which is introduced in each case into the congruent bores 37 or insertion openings, the flange plate 33 is screwed to the base body 2, a nut 39 being used (FIG. 1). Of course, the nut 39 can also be arranged in the bore 37. The opening 5 of the base body 2 is congruent with the opening 36 of the flange plate 33 here.

A projection 41 is arranged on the base surface 34. The projection 41 is arranged on the base surface 34 in such a way that said projection 41 can be connected via the second attachment section 13 on the side lying opposite the damper connecting element 14. The projection 41 is configured to be somewhat smaller than the second attachment section 13 and has, on the one hand, a bore through which a screw 42 is guided to attach the flange plate 33 to the second attachment section 13. The screw 42 is screwed into a threaded hole in the second attachment section 13. On the other hand, the projection 41 has a bore 43 which is of similar configuration to the bore 37. In the bore 43, a screw 44 is held by its screw head. With its stem, the screw 44 engages through the second attachment section 13 and is screwed into a threaded hole of the attachment side of the damper connecting element 14, as a result of which a frictionally locking connection of the flange plate 33 to the base body 2 is also achieved.

The flange plate 33 has a double function. On the one hand, it holds the wheel bearing. On the other hand, the flange plate 33 reinforces the base body 2. The flange plate 33 is punched in one piece with its projection 41, from a planar piece of sheet metal, but can also be cut out of the piece of sheet metal in some other way, for example by means of a laser.

As a result, an improved pivot bearing 1 is made available which, while maintaining safety and fulfilling the wide variety of functions, is reduced in weight, has an increased degree of rigidity and can also be manufactured extremely economically.

1. A pivot bearing for connecting wheel guiding elements to a wheel of a vehicle comprising:
a base body; and
a flange plate
wherein the base body is comprised of a planar piece of sheet metal and the flange plate is connected to the base body in a frictionally locking fashion.

2. The pivot bearing of claim 1, wherein the base body has attachment sections for attaching wheel guiding elements.

3. The pivot bearing of claim 2, wherein the base body is fabricated in one piece with its attachment sections.

4. The pivot bearing of claim 3, wherein the base body is punched from a planar piece of sheet metal.

5. The pivot bearing of claim 2, wherein the flange plate has a projection which is configured so as to be adapted to one of the attachment sections of the base body.

6. The pivot bearing of claim 5, wherein the base body has a first attachment and a second attachment and the projection is configured so as to be adapted to the second attachment.

7. The pivot bearing of claim 5, wherein the flange plate has bores which are of hexagonal configuration.

8. The pivot bearing as claimed in claim 1, wherein the flange plate is connected by its projection in a frictionally locking fashion to the base body at one location, and to a damper connecting element at another location.

9. The pivot bearing of claim 2, wherein the base body has reinforcing ribs.

10. The pivot bearing of claim 2, wherein the frictionally locking connection is a screw connection.
